(19) United States
(12) Patent Application Publication
(10) Pub. No.: US 2005/0276179 A1
(43) Pub. Date: Dec. 15, 2005

(54) Optical pickup system and information recording and/or reproducing apparatus employing the same

(75) Inventor: Wen-Hsin Sun, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/115,462

(22) Filed: Apr. 27, 2005

(30) Foreign Application Priority Data
Jun. 11, 2004 (TW) 93116815

(51) Int. Cl. G11B 7/00; G11B 7/135

(52) U.S. Cl. 369/44.37; 369/112.01; 369/112.23; 369/44.23

(57) ABSTRACT

An optical pickup system includes first and second light sources, a composite prism, a reflective prism, a collimating lens and an objective lens. The first light source emits a first light beams with a first wavelength. The second light source emits a second light beams with a second wavelength greater than the first wavelength. The composite prism includes a first, second and third prism for receiving the first and second light beams from the first and second prism. The reflective prism includes first and second units for internally reflecting the first and second light beams. The collimating lens is disposed in a common optical path for collimating the first and second light beams. The objective lens is disposed in the common optical path for focusing the first and second light beams from the collimating lens on two different types of optical recording media.

### BACKGROUND OF THE INVENTION

1. Field of the Invention

The present invention relates to an optical pickup system used in an information recording and/or reproducing apparatus, and more particularly to an optical pickup system for accessing different types of optical recording media and an information recording and/or reproducing apparatus employing the same.

2. Prior Art

In recent years, in order to satisfy ongoing requirements for recording and/or reproducing large quantities of data on recording media, many manufacturers have sought to increase the recording density of recording media. The recording density of a recording medium is determined by the size of a light spot illuminating the recording medium. Generally, the size of the light spot is proportional to the wavelength of the light, and inversely proportional to the numerical aperture (NA) of an objective lens that focuses the light. Therefore, reducing the wavelength or increasing the NA can increase the recording density of the recording medium.

An industry-wide standard relating to a next generation optical disk such as a high definition-digital versatile disk (HD-DVD) has been proposed to satisfy the demand for increased recording density of recording media. The HD-DVD standard employs a laser diode generating a blue laser with a wavelength of 405 nm, an objective lens having an NA of 0.85, and a light transmission protective layer of the optical disk having a thickness of 0.1 mm.

It is important to be able to employ a conventional digital versatile disk (DVD) in an HD-DVD apparatus, because DVDs are still very popular whereas HD-DVDs are still relatively nascent. However, various optical conditions for recording/reproducing on/from DVDs and HD-DVDs are different from each other, as shown in table 1.

TABLE 1

| | DVD | | HD-DVD | |
|---|---|---|---|---|
| wavelength | 650 | nm | 405 | nm |
| numerical aperture (NA) | 0.6 | | 0.85 | |
| recording capacity | 4.7 | GB | more than 20 | GB |
| thickness of protective layer | 0.6 | mm | 0.1 | mm |

As can be seen, different optical disks need different objective lenses with different NAs. Therefore in a single conventional HD-DVD apparatus, there are usually two different objective lenses respectively adapted to DVDs and HD-DVDs. However, this makes the volume of the HD-DVD apparatus large. To avoid this shortcoming, another conventional HD-DVD apparatus with only one objective lens and a wavelength selector has been developed. The wavelength selector changes an effective diameter of the objective lens by means of limiting the luminous flux propagating to the objective lens. With the help of the wavelength selector, the objective lens in the HD-DVD apparatus is suitable for reading and reproducing not only with respect to HD-DVDs but also with respect to DVDs.

An information recording and/or reproducing apparatus employing an optical pickup system for accessing two different optical recording media is disclosed in U.S. patent application publication no. 2003/0090988A1. This publication discloses an information recording and/or reproducing apparatus including two laser diodes, a CZBO (Carl Zeiss Binocular-Ocular) prism, a penta prism, a condensing lens, and an objective lens. The two laser diodes emit two laser beams with different wavelengths, e.g., 405 nm and 650 nm, and these laser beams are used in recording and/or reproducing operations for HD-DVDs and DVDs respectively. The condensing lens condenses the two laser beams respectively. The objective lens focuses the two laser beams on the two different optical disks. In this apparatus, the size of the apparatus is reduced to a certain extent because: (i) the CZBO prism, the penta prism and the objective lens are in a common optical path; and (ii) the CZBO prism transmits the two laser beams by two reflections, as well as the penta prism doing so.

However, the penta prism reflects the light beams twice only. Therefore the optical length of the optical system is still relatively long, and the size of the information recording and/or reproducing apparatus is still unduly large.

Accordingly, what is needed is a more compact optical pickup system for accessing a plurality of different types of optical recording media. What is also needed is an optical pickup apparatus employing such kind of compact optical pickup system.

### SUMMARY

An optical pickup system for accessing two different types of optical recording media includes first and second light sources, a composite prism, a reflective prism, a collimating lens and an objective lens. The first light source emits a first light beams with a first wavelength. The second light source emits a second light beams with a second wavelength greater than the first wavelength. The composite prism includes a first prism facing the first light source, a second prism facing the second light source, and a third prism for receiving the first and second light beams from the first and second prism. The reflective prism internally reflects the first and second light beams from the third prism. The reflective prism includes a first unit for the first and second light beams to be reflected therewithin and to propagate therethrough, and a second unit for receiving the first and second light beams from the first unit, and for the first and second light beams to propagate therethrough. The collimating lens is disposed in a common optical path for collimating the first and second light beams from the third prism. The objective lens is disposed in the common optical path for focusing the two light beams from the collimating lens on two different optical recording media.

An apparatus employing an optical pickup system for accessing two different types of optical recording media includes: the optical pickup system described above; a drive mechanism for changing a relative position between selected one of the first and second optical recording media and the optical pickup system; and an electrical signal processor for receiving signals output from the optical pickup system and performing calculations on the signals to obtain desired information.

Other objects, advantages and novel features of the present invention will be drawn from the following detailed description of preferred embodiments with the attached drawings, in which:

### BRIEF DESCRIPTION OF THE DRAWINGS

FIG. 1 is a schematic, isometric view of an optical pickup system according to a preferred embodiment of the present invention, showing optical paths thereof;

FIG. 2 is an enlarged, top view of a composite prism of the optical pickup system of FIG. 1, showing optical paths thereof;

FIG. 3 is an enlarged, side view of a reflective prism of the optical pickup system of FIG. 1, showing optical paths thereof;

FIG. 4 is a schematic, top view of a wavelength selector of the optical pickup system of FIG. 1; and

FIG. 5 is a cross-sectional view of the wavelength selector of FIG. 4 taken along line V-V thereof.

### DETAILED DESCRIPTION OF THE INVENTION

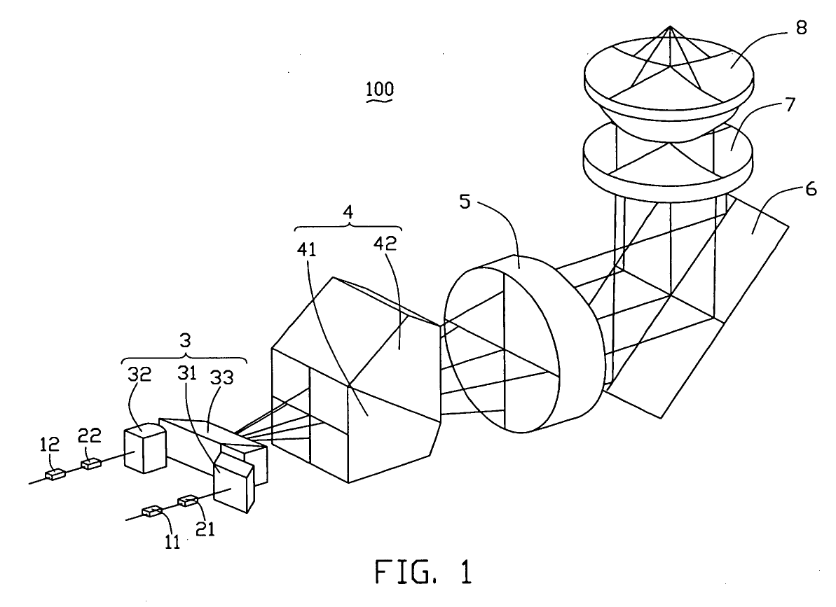

Referring to FIG. 1, an optical pickup system 100 according to a preferred embodiment of the present invention is illustrated. The optical pickup system 100 is used in an information recording and/or reproducing apparatus for accessing a plurality of different optical recording media (not shown). The optical pickup system 100 includes first and second semiconductor modules 11, 12, first and second diffraction elements 21, 22, a composite prism 3, a reflective prism 4, a collimating lens 5, a mirror 6, a wavelength selector 7, and an objective lens 8. The composite prism 3, the reflective prism 4, the collimating lens 5, the mirror 6, the wavelength selector 7 and the objective lens 8 are positioned in a common optical path (not labeled).

The first and second semiconductor modules 11, 12 are positioned side by side, and are arranged on a same side of the composite prism 3. The first semiconductor module 11 includes a first light source (not shown) and a first detector (not shown). The first light source emits first light beams having a first wavelength of 405 nm, which is suitable for a first optical disk (not shown) such as an HD-DVD. The first detector is used to receive the first light beams reflected from the first optical disk. The second semiconductor module 12 includes a second light source (not shown) and a second detector (not shown). The second light source emits second beams having a second wavelength of 650 nm, which is suitable for a second optical disk (not shown) such as a DVD. The second detector is used to receive the second light beams reflected from the second optical disk.

The first and second diffraction elements 21, 22 are located respectively between the first and second semiconductor modules 11, 12 and the composite prism 3 (described as below), and are opposite to the first and second light sources respectively.

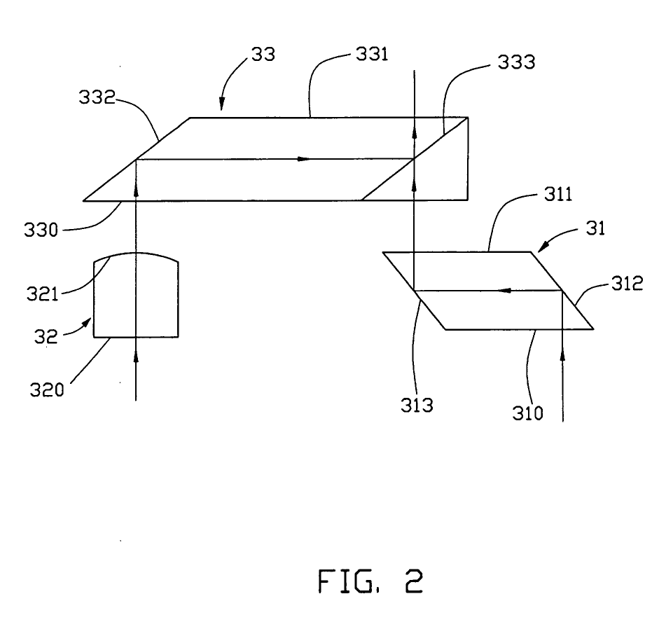

Referring also to FIG. 2, the composite prism 3 includes first, second and third prisms 31, 32, 33. The first and second prisms 31, 32 are located on a same side of the third prism 33. The first prism 31 has four first surfaces 310, 311, 312, 313. An angle between the first surfaces 310 and 312 is approximately 45o. The first surface 313 is parallel to the first surface 312. The first surface 313 has a function of selectively permitting the light beams to pass therethrough, according to the different wavelengths. The second prism 32 has two second surfaces 320, 321. The second surface 321 is an aspherical surface, which has functions of compensating spherical aberration of and collimating the second light beams emitted from the second light source. The third prism 33 includes three third surfaces 330, 331, 332, and an interface 333. The interface 333 is parallel to the third surface 332. The interface 333 has a function of selectively reflecting light beams or permitting the light beams to pass therethrough, according to different wavelengths of the light beams.

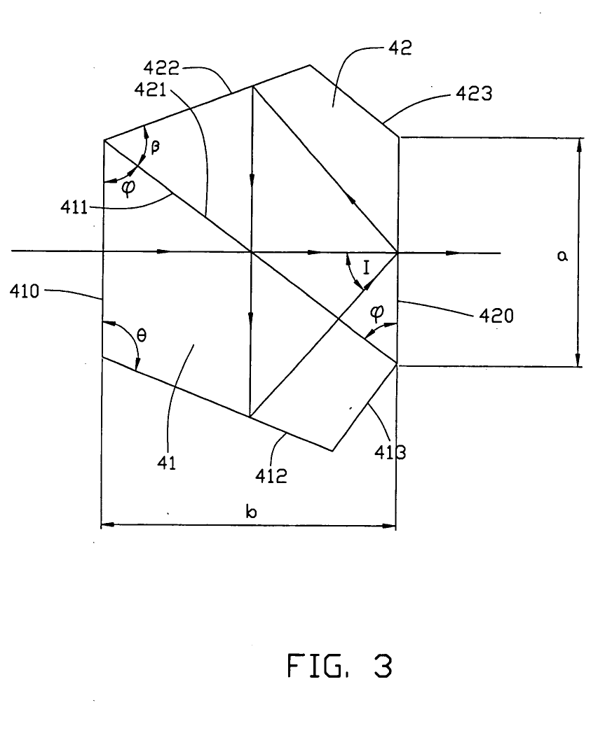

Referring also to FIG. 3, the reflective prism 4 is located between the composite prism 3 and the collimating lens 5 (described below). The reflective prism 4 includes a first unit 41 and a second unit 42. The first and second units 41, 42 are made of a same material, such as glass or plastic. The first unit 41 is a quadrangular prism having four fourth surfaces 410, 411, 412, 413. The fourth surface 411 has a stack of reflective films on a center portion thereof, and the fourth surface 412 has a stack of reflective films thereon. The second unit 42 is a quadrangular prism having four fourth surfaces 420, 421, 422, 423. The fourth surface 421 has a stack of reflective films on a center portion thereof, and the fourth surface 422 has a stack of reflective films thereon. In alternative embodiments, any one or more of the stacks of reflective films may instead be a single reflective film. The first unit 41 defines an angle φ between the fourth surfaces 410 and 411, with φ being approximately 45o. The first unit 41 also defines an angle θ between the fourth surfaces 410 and 412, with θ being approximately 112.5o. The second unit 42 defines an angle β between the fourth surfaces 421 and 422, with β being approximately 67.5o. The fourth surface 421 adjoins the fourthe surface 411, and the fourth surface 420 is parallel to the fourth surface 410. Therefore an angle between the fourth surfaces 420 and 421 is equal to φ. A height “a” of the fourth surface 420 is approximately 4 mm, and a distance “b” between the fourth surfaces 410 and 420 is approximately 4.828 mm. The first and second units 41, 42 are attached to each other at the fourth surfaces 411 and 421.

Light beams incident on the fourth surface 410 are internally reflected by the fourth surfaces 411 and 412, pass through peripheral portions of the fourth surfaces 411, 421, and propagate to the fourth surface 420 with an incident angle “I.” According to the law of total reflection, if the incident angle “I” is greater than or equal to an angle of total reflection, the light beams are totally reflected by the fourth surface 420 when the light beams propagate from the optically denser medium to the optically less dense medium. If the incident angle “I” is less than the angle of the total reflection, the light beams pass through the fourth surface 420. Accordingly, in the preferred embodiment, the light beams that propagate to the fourth surface 420 with the incident angle “I” as shown are totally reflected therefrom. The light beams are then reflected by the fourth surfaces 411 and 412, and propagate to the fourth surface 420 at a zero angle of incidence. The light beams thus pass through the fourth surface 420 to the collimating lens 5.

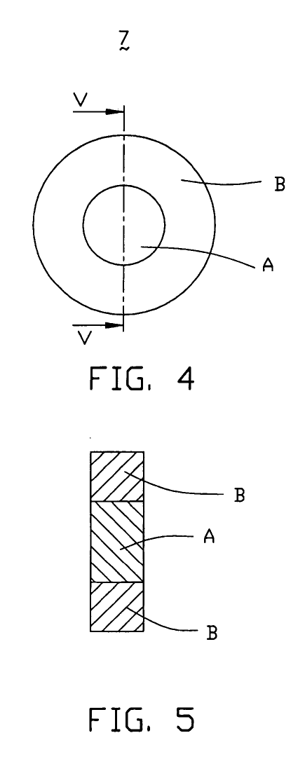

Referring also to FIGS. 4 and 5, the wavelength selector 7 is located between the mirror 6 and the objective lens 8. The wavelength selector 7 defines a central portion A, and a peripheral portion B around the central portion A. The portion A allows light beams with all wavelengths, including the first and the second light beams, to pass therethrough. The portion B only allows light beams with short wavelengths, such as the second light beams, to pass therethrough.

Referring to FIG. 1 again, in the present embodiment, both the collimating lens 5 and the objective lens 8 have optical parameters corresponding to the first wavelength for the first optical disk such as the HD-DVD.

When recording information on and/or reproducing information from the first optical disk, the first light beams with the first wavelength of 405 nm emitted from the first light source propagate through the first diffraction element 21, are incident on the first surface 310, are reflected by the first surfaces 312 and 313, and then pass through the first surface 311. The first light beams pass through the third surface 330 of the third prism 33, the interface 333, and the third surface 331 in sequence. The first light beams thus exit the third prism 33, are incident on the fourth surface 410 of the reflective prism 4, are reflected by the fourth surfaces 411, 412, pass through the peripheral portions of the fourth surfaces 411, 421, and then propagate to the fourth surface 420 with the incident angle “I.” Because the incident angle “I” is greater than the angle of total reflection, the first light beams are reflected by the fourth surface 420. The first light beams are then reflected by the fourth surfaces 422, 421, pass through the fourth surface 420, and propagate to the collimating lens 5. The collimating lens 5 condenses the first light beams into parallel light beams. After exiting the collimating lens 5, the first light beams are reflected by the mirror 6 toward the objective lens 8, and are incident on the wavelength selector 7. The wavelength selector 7 does not block any of the first light beams, so that the first light beams completely propagate through the wavelength selector 7 and are incident on the objective lens 8. The first light beams are converged to a light spot (not labeled) on the first optical disk by the objective lens 8. The first optical disk reflects first signal light beams, and then the first signal light beams follow the above-mentioned optical path. Eventually, the first signal light beams are refracted by the first diffraction element 21 to the first detector. The first detector converts the first signal light beams to electrical signals. After this, an electrical signal processor of the information recording and/or reproducing apparatus receives electrical signals and obtains desired information. Furthermore, a drive mechanism of the information recording and/or reproducing apparatus changes a relative position between the first optical disk and the optical pickup system 100, also based on electrical signals output from the optical pickup system 100.

In the above-described first optical path from the first light source to the objective lens 8, parameters of all the components are in accord with the first disk. In particular, the objective lens 8 matches the parameters of the first optical disk, such as the wavelength, the required NA, and the thickness of the protective layer of the first optical disk. Therefore, the objective lens 8 helps prevent optical aberration from occurring in the optical pickup system 100. Because the first light beams undergo five reflections in the reflective prism 4, the optical length of the optical pickup system 100 is shortened. Therefore the size of the optical pickup system 100 is compact.

When recording information on and/or reproducing information from the second optical disk, the second light beams with the second wavelength of 650 nm emitted by the second light source propagate through the second diffraction element 22, are incident on the second surface 320, and propagate to the second surface 321 of the second prism 32. The second light beams then propagate to the third surface 330 of the third prism 33, and are reflected by the third surface 332 and the interface 333 in sequence. The second light beams then pass through the third surface 331, and are incident on the fourth surface 410 of the reflective prism 4. Within the reflective prism 4, the second light beams undergo the same five internal reflections as described above in relation to the first light beams. The second light beams thus pass through the fourth surface 420, and propagate to the collimating lens 5. The collimating lens 5 collimates the second light beams into parallel light beams, which propagate to the mirror 6. The mirror 6 reflects the second light beams to the wavelength selector 7. The portion A of the wavelength selector 7 does not block the second light beams, but the portion B does. Accordingly, the second light beams can partially propagate through the wavelength selector 7. The second light beams are converged to a light spot (not labeled) on the second disk by the objective lens 8. The second optical disk reflects second signal light beams, and the second signal light beams follow the above-mentioned optical path. Eventually, the second signal light beams are refracted by the second diffraction element 22 to the second detector. The second detector converts the second light beams to electrical signals. After this, the electrical signal processor of the information recording and/or reproducing apparatus receives electrical signals and obtains desired information. Furthermore, the drive mechanism of the information recording and/or reproducing apparatus changes a relative position between the second optical disk and the optical pickup system 100, also based on electrical signals output from the optical pickup system 100.

In the above-described second optical path from the second light source to the objective lens 8, optical aberration is significantly corrected because the second surface 321 of the second prism 32 is an aspherical surface, and because the wavelength selector 7 is used to control the effective diameter of the objective lens 8 by limiting the luminous flux propagating therethrough. The size of the optical pickup system 100 is compact because: (i) an overall optical length is shortened because the second light beams undergo two reflections in the third prism 33 and five reflections in the reflective prism 4, and (ii) optical components such as the composite prism 3, the reflective prism 4, the collimating lens 5, the mirror 6, the wavelength selector 7 and the objective lens 8 are shared with the first light beams used to access the first optical disk.

Although the present invention has been described with reference to specific embodiments, it should be noted that the described embodiments are not necessarily exclusive, and that various changes and modifications may be made to the described embodiments without departing from the scope of the invention as defined by the appended claims.

1. An optical pickup system for accessing two different types of optical recording media, comprising:
a first light source emitting first light beams with a first wavelength;
a second light source emitting second light beams with a second wavelength greater than the first wavelength;
a composite prism comprising a first prism facing the first light source, a second prism facing the second light source, and a third prism for receiving the first and second light beams from the first and second prisms;
a reflective prism for internally reflecting the first and second light beams from the third prism, the reflective prism comprising a first unit for the first and second light beams to be reflected therewithin and to propagate therethrough, and a second unit for receiving the first and second light beams from the first unit, and for the first and second light beams to be reflected therewithin and to propagate therethrough;
a collimating lens disposed in a common optical path for collimating the first and second light beams from the third prism; and
an objective lens disposed in the common optical path for focusing the first and second light beams from the collimating lens on the two different types of optical recording media.

2. The optical pickup system as described in claim 1, wherein the first unit has an incident surface for receiving the first and second light beams from the third prism, and at least two reflective surfaces for reflecting the first and second light beams, one of the reflective surfaces having a portion for the first and second light beams reflected by the reflective surfaces to pass therethrough.

3. The optical pickup system as described in claim 2, wherein the second unit has at least two reflective surfaces for reflecting the first and second light beams received from the first unit, and an emergent surface, the emergent surface being for reflecting the first and second light beams to one of the reflective surfaces of the second unit, and for the first and second light beams reflected by another of the reflective surfaces of the second unit to pass therethrough.

4. The optical pickup system as described in claim 3, wherein one of the reflective surfaces of the first unit abuts one of the reflective surfaces of the second unit.

5. The optical pickup system as described in claim 4, wherein each of the two reflective surfaces in abutment with each other has one or more reflective films on a center portions thereof, the first and second light beams are reflected by the reflective films, and the first and second light beams can propagate through a peripheral portion of each of the two reflective surfaces in abutment with each other.

6. The optical pickup system as described in claim 5, wherein the incident surface is parallel to the emergent surface.

7. The optical pickup system as described in claim 6, wherein an angle in the first unit between the incident surface and the reflective surface abutting one of the reflective surfaces of the second unit is 45o, and another angle in the first unit between the incident surface and another of the reflective surfaces is 112.5o.

8. The optical pickup system as described in claim 6, wherein an angle in the second unit between two reflective surfaces is 67.5o, and another angle in the second unit between the emergent surface and the reflective surface abutting one of the reflective surfaces of the first unit is 45o.

9. The optical pickup system as described in claim 1, wherein the first and second prisms are positioned side by side, and are disposed on a same side of the third prism.

10. The optical pickup system as described in claim 9, wherein the third prism has an interface with a function of selectively allowing the first light beams to pass therethrough and the second light beams to be reflected therefrom.

11. The optical pickup system as described in claim 10, wherein the first prism reflects the first light beams twice, and the third prism reflects the second light beams twice.

12. The optical pickup system as described in claim 9, wherein the second prism has an apherical surface.

13. The optical pickup system as described in claim 1, further comprising a wavelength selector disposed between the collimating lens and the objective lens.

14. The optical pickup system as described in claim 13, wherein a portion of the wavelength selector allows all of the first and second light beams to pass therethrough, and another portion of the wavelength selector blocks the second light beams.

15. The optical pickup system as described in claim 1, further comprising a mirror positioned between the collimating lens and the wavelength selector.

16. The optical pickup system as described in claim 1, further comprising two diffraction elements facing the first and second light sources respectively, for diffracting first and second light beams returned from the two different types of optical recording media.

17. The optical pickup system as described in claim 16, further comprising two detectors adjacent to the first and second light sources respectively, for receiving the diffracted first and second light beams.

18. An apparatus for accessing two different types of optical recording media, comprising:
an optical pickup system comprising:
a first light source emitting first light beams with a first wavelength;
a second light source emitting second light beams with a second wavelength greater than the first wavelength;
a composite prism comprising a first prism facing the first light source, a second prism facing the second light source, and a third prism for receiving the first and second light beams from the first and second prisms;
a reflective prism for internally reflecting the first and second light beams from the third prism, the reflective prism comprising a first unit for the first and second light beams to be reflected therewithin and to propagate therethrough, and a second unit for receiving the first and second light beams from the first unit, and for the first and second light beams to be reflected therewithin and to propagate therethrough;
a collimating lens disposed in a common optical path for collimating the first and second light beams from the third prism; and
an objective lens disposed in the common optical path for focusing the first and second light beams from the collimating lens on the two different types of optical recording media;
a drive mechanism for changing a relative position between a selected one of the first and second optical recording media and the optical pickup system; and
an electrical signal processor for receiving signals output from the optical pickup system, and performing calculations on the signals to obtain desired information.

19. An information recording and/or reproducing apparatus for retrieving information from at least two types of optical recording media, comprising:
a first light source emitting first light beams with a first wavelength for one of said at least two types of optical recording media;
a second light source emitting second light beams with a second wavelength greater than said first wavelength for another of said at least two types of optical recording media;
a reflective prism disposed to face said first and second light source and be capable of accepting said first and second light beams therefrom so as to reflect said first and second light beams therein for more than two times before said first and second light beams are transmitted out of said reflective prism; and
an objective lens disposed between said reflective prism and said at least two types of optical recording media so as to accept said reflected first and second light beams from said reflective prism to said at least two types of optical recording media, and return said first and second light beams from said at least two types of optical recording media back to said reflective prism.

20. The information recording and/or reproducing apparatus as described in claim 19, wherein said reflective prism comprising a first unit and a second unit to respectively allow said first and second light beams to be reflected at least twice therein.
